(19) United States
(12) Patent Application Publication
(10) Pub. No.: US 2026/0326684 A1
(43) Pub. Date: Oct. 22, 2026

(54) DECORATIVE SHEET

(71) Applicant: TOKAI CHEMICAL INDUSTRIES, LTD., Gifu (JP)

(72) Inventors: Takemasa OKUMURA, Gifu (JP); Yosuke Naruse, Gifu (JP)

(73) Assignee: TOKAI CHEMICAL INDUSTRIES, LTD., Gifu (JP)

(21) Appl. No.: 19/694,980

(22) Filed: Jun. 2, 2026

Related U.S. Application Data
(63) Continuation of application No. PCT/JP2024/043303, filed on Dec. 6, 2024.

(30) Foreign Application Priority Data
Dec. 28, 2023 (JP) 2023-222871

(51) Int. Cl. B60R 13/02; B60Q 3/54

(52) U.S. Cl. CPC B60R 13/02; B60Q 3/54; B60R 2013/0287

(57) ABSTRACT

A decorative sheet includes: a skin layer, being light-transmissive; an intermediate layer, arranged on a back side of the skin layer and being light-transmissive; a design layer, arranged on a back side of the intermediate layer; and a base layer, arranged on a back side of the design layer and being light-transmissive. When viewed from an outer side, the design layer has a shielding part and an opening part arranged adjacent to the shielding part via a boundary. When viewed from the outer side, multiple dot parts are arranged inside the opening part. The dot parts are arranged so as to become sparse from dense toward an inner side of the opening part from the boundary. The opening part has higher light transmittance than the shielding part and the dot parts. The dot part has light transmittance that is the same as or higher than the shielding part.

### CROSS-REFERENCE TO RELATED APPLICATION

This application is a continuation of PCT International Application No. PCT/JP2024/043303, filed on Dec. 6, 2024, which claims priority under 35 U.S.C § 119(a) to Japanese Patent Application No. 2023-222871, filed on Dec. 28, 2023. Each of the above applications is hereby expressly incorporated by reference, in its entirety, into the present application.

### BACKGROUND

### Technical Field

The disclosure relates to a decorative sheet used, for example, in an interior part of a vehicle.

### Description of Related Art

In the field of the interior of vehicles, the development of decorative sheets capable of switching designs visible from inside the vehicle compartment by turning on and off the backlight is advancing. For example, Patent Document 1 discloses a display device including a surface protection layer, a pattern layer (design layer) and a void part, a base material, a dimming sheet, a light-emitting display body (display), and a display control device. The surface protection layer, the pattern layer and the void part, the base material, the dimming sheet, and the light-emitting display body are stacked in this order from the outer side (vehicle compartment interior side) toward the back side. The display control device is arranged separately from the members.

The surface protection layer is colorless and transparent. A pattern such as a wood grain vessel pattern or a marble pattern is printed on the pattern layer. The pattern layer is printed on the base material surface. The void part is juxtaposed with the pattern layer. The void part corresponds to the portion of the base material surface where the pattern layer is not printed.

The display control device can adjust the light transmittance of the dimming sheet in response to turning on and off of the light-emitting display body. Specifically, the display control device can adjust the light transmittance of the dimming sheet, so as to transmit light when the light-emitting display body is turned on and not to transmit light when the light-emitting display body is turned off. When the light-emitting display body is turned on, since the dimming sheet transmits light, the design of the pattern layer tends to appear on the surface of the surface protection layer. On the other hand, when the light-emitting display body is turned off, since the dimming sheet does not transmit light, the design of the pattern layer tends not to appear on the surface of the surface protection layer.

### PRIOR ART DOCUMENT(S)

### Patent Document(s)

[Patent Document 1] Japanese Patent Application Laid-Open Publication No. 2021-162723

However, according to the decorative sheet of the same document, when the light-emitting display body is turned off, the design of the pattern layer may tend to appear on the surface of the surface protection layer under certain conditions. That is, when the light-emitting display body is turned off, a portion of light from the outside (outer side of the decorative sheet) is reflected at the base material surface. The portion of the light follows a path of surface protection layer→void part→base material surface→void part again→surface protection layer again, and is visually recognized by the user. Also, another portion of the light from the outside is reflected at the back surface of the surface protection layer (without reaching the base material surface) and is visually recognized by the user. Here, in the case where the difference between the reflection at the base material surface and the reflection at the back surface of the surface protection layer is excessively large, the void part tends to be visually recognized from the outside. Therefore, the disclosure aims to provide a decorative sheet in which the opening part of the design layer is difficult to be visually recognized when the backlight is turned off.

### SUMMARY

An aspect of the disclosure provides a decorative sheet. The decorative sheet includes: a skin layer, being light-transmissive; an intermediate layer, arranged on a back side of the skin layer and being light-transmissive; a design layer, arranged on a back side of the intermediate layer; and a base layer, arranged on a back side of the design layer and being light-transmissive. When viewed from an outer side, the design layer has a shielding part and an opening part arranged adjacent to the shielding part via a boundary. When viewed from the outer side, a plurality of dot parts are arranged inside the opening part. The dot parts are arranged so as to become sparse from dense toward an inner side of the opening part from the boundary. The opening part has higher light transmittance than the shielding part and the dot parts. The dot part has light transmittance equal to or higher than the shielding part.

### BRIEF DESCRIPTION OF THE DRAWINGS

FIG. 1 is a partial perspective view of a door trim in which a decorative sheet of the first embodiment is arranged.

FIG. 2 is a perspective view inside a frame II of FIG. 1.

FIG. 3 is an exploded perspective view inside the frame II of FIG. 1.

FIG. 4 is a surface view of a design layer inside the frame II of FIG. 1.

FIG. 5 is an enlarged view inside a frame V of FIG. 4.

FIG. 6 is a cross-sectional view in a VI-VI direction of FIG. 5.

FIG. 7 is a partial surface view of a design layer of a decorative sheet of a second embodiment.

FIG. 8 is a partial surface view of a design layer of a decorative sheet of a third embodiment.

(A) of FIG. 9 is a surface view of the dot part of a decorative sheet of another embodiment (first of the examples). (B) of FIG. 9 is a surface view of a dot part of a decorative sheet of another embodiment (second of the examples). (C) of FIG. 9 is a surface view of a dot part of a decorative sheet of another embodiment (third of the examples). (D) of FIG. 9 is a surface view of a dot part of a decorative sheet of another embodiment (fourth of the examples).

### DESCRIPTION OF THE EMBODIMENTS

To solve the above issues, a decorative sheet of the disclosure includes: a skin layer, being light-transmissive; an intermediate layer, arranged on a back side of the skin layer and being light-transmissive; a design layer, arranged on a back side of the intermediate layer; and a base layer, arranged on a back side of the design layer and being light-transmissive. When viewed from an outer side, the design layer has a shielding part and an opening part arranged adjacent to the shielding part via a boundary. When viewed from the outer side, multiple dot parts are arranged inside the opening part. The dot parts are arranged so as to become sparse from dense toward an inner side of the opening part from the boundary. The opening part has higher light transmittance than the shielding part and the dot parts. The dot part has light transmittance equal to or higher than the shielding part.

Hypothetically, the case where the dot parts are not arranged inside the opening part is assumed. In this case, when the backlight is turned off, a portion of the light incident on the decorative sheet from the outer side of the skin layer is reflected on the surface of the shielding part (reflection of the shielding part) and is visually recognized by the user. Also, when the backlight is turned off, another portion of the light incident on the decorative sheet from the outer side of the skin layer transmits through the opening part, is reflected on the surface of the base layer (reflection of the base layer), and is visually recognized by the user.

A difference occurs between the reflection of the shielding part and the reflection of the base layer due to the difference in light reflectance between the surface of the shielding part and the surface of the base layer. Therefore, the boundary between the shielding part and the opening part becomes easily visually recognized by the user.

Regarding this point, according to the configuration, multiple dot parts are arranged inside the opening part. In addition, the dot parts are arranged so as to become sparse from dense from the boundary between the shielding part and the opening part toward the inner side of the opening part. According to the above, when the backlight is turned off, the boundary between the shielding part and the opening part is visually recognized easily. By densely arranging the dot parts near the boundary A, the boundary can be blurred. Therefore, the boundary can be suppressed from being visually recognized by the user.

Also, on the side surface of the dot part (a surface connecting the outer surface and the back surface), at least one of absorption, attenuation, and reflection of the light reflected on the base layer surface occurs. For this reason, the boundary (the outer edge of the dot part) between the dot part and the portion inside the opening part where the dot part is not arranged (dot-free portion) can be blurred.

(1-1) In the configuration of (1), it may also be configured that the base layer is made of thermoplastic elastomer and light-diffusive. The base layer made of thermoplastic elastomer has multiple pores. Macroscopically, the surface of the base layer is white. For this reason, the surface of the base layer easily reflects light. Therefore, when the backlight is turned off, the boundary between the shielding part and the opening part is visually recognized easily. The decorative sheet of the disclosure is suitable for the decorative sheet having the base layer with high light reflectivity.

(2) In the configuration of (1), it may also be that when viewed from the outer side, inside the opening part, an outside dot area arranged adjacent to the boundary, and an inside dot area arranged adjacent to the outside dot area are defined, and in the outside dot area, the dot parts are densely arranged relative to the inside dot area.

According to the configuration, inside the opening part, the outside dot area where the dot parts are densely arranged and the inside dot area where the dot parts are sparsely arranged are defined. With the two types of dot areas, the dot parts can be arranged so as to become sparse from dense from the boundary toward the inner side of the opening part.

(3) In the configuration of (2), it may also be that a direction orthogonal to an extension direction of the boundary is defined as a width direction, among both ends of the outside dot area in the width direction, an end on a side of the shielding part is defined as an outside end, and an end on a side of the opening part is defined as an inside end, the outside end is the boundary, and when a total length of the opening part in the width direction is defined as 100%, the inside end is arranged at a position at or within 33% inward from the boundary in the width direction.

According to the configuration, when the total length of the opening part in the width direction is defined as 100%, compared to the case where the inside end is arranged at a position exceeding 33% inward from the boundary in the width direction, the width of the outside dot area (area where the dot parts are densely arranged) can be set narrow, and the width of the inside dot area (area where the dot parts are sparsely arranged) can be set wide. For this reason, the boundary can be intensively blurred. Also, an excessive decrease in the light transmittance of the opening part can be suppressed.

(4) In the configuration of (2), it may also be that when viewed from the outer side, an arrangement density of the dot parts in the outside dot area gradually decreases from the boundary toward an inner side of the opening part.

Hypothetically, the case where the arrangement density of the dot parts changes abruptly from the boundary between the shielding part and the opening part toward the inner side of the opening part is assumed. In this case, when the backlight is turned off, the boundary where the arrangement density of the dot parts changes (hereinafter referred to as “arrangement density boundary” as appropriate) tends to be visually recognized by the user. Regarding this point, according to the configuration, the arrangement density of the dot parts gradually decreases from the boundary between the shielding part and the opening part toward the inner side of the opening part. Therefore, the arrangement density boundary can be blurred.

Furthermore, the light transmittance differs between the portion where the arrangement density of the dot parts is high and the portion where the arrangement density is low. Therefore, when the arrangement density of the dot parts changes abruptly from the boundary between the shielding part and the opening part toward the inner side of the opening part, the difference in light transmittance becomes large. Accordingly, when the backlight is turned on, the difference in luminosity is easy for the user to visually recognize. Regarding this point, according to the configuration, the arrangement density of the dot parts gradually decreases from the boundary between the shielding part and the opening part toward the inner side of the opening part. Therefore, the difference in light transmittance is small. Accordingly, when the backlight is turned on, the difference in luminosity is difficult for the user to visually recognize.

(5) In the configuration of (2), it may also be that when viewed from the outer side, an arrangement density of the dot parts in the outside dot area is uniform. According to the configuration, the occurrence of the boundary in the arrangement density of the dot parts in the outside dot area can be suppressed. Also, since the boundary in the arrangement density of the dot parts itself is unlikely to occur, the light transmittance tends to be uniform throughout the entire outside dot area. For this reason, when the backlight is turned on, it is difficult for the user to visually recognize the difference in luminosity.

(6) In the configuration of (2), it may also be that when viewed from the outer side, when an area of the inside dot area is defined as 100%, a total area of the dot parts in the inside dot area is 25% or more and 50% or less.

According to the configuration, compared to the case where the total area of the dot parts is less than 25%, it is possible to suppress the opening part from being visually recognized by the user when the backlight is turned off. Also, compared to the case where the total area of the dot parts exceeds 50%, it is possible to suppress the decrease in the light transmittance of the opening part when the backlight is turned on.

(7) In the configuration of (1), it may also be that when viewed from the outer side, a diameter of a circumscribed circle of the dot part is 1.5 mm or less. According to the configuration, compared to the case where the diameter of the circumscribed circle exceeds 1.5 mm, it is possible to suppress the dot part itself from being visually recognized by the user when the backlight is turned off.

(8) In the configuration of (1), it may also be that when viewed from the outer side, the opening part exhibits a band shape, and a length of the opening part in a short-side direction is 3 mm or more. Here, “band shape” means that the aspect ratio of the opening part is (short-side direction length:longitudinal direction length)=(1:more than 1). In the case where the short-side direction length of the opening part is 3 mm or more, the boundary between the shielding part and the opening part tends to be visually recognized by the user when the backlight is turned off. According to the configuration, multiple dot parts can be arranged in an area where the boundary blurring effect can be effectively exhibited (an area where the length of the opening part in the short-side direction is 3 mm or more). Therefore, the boundary between the shielding part and the opening part can be suppressed from being visually recognized by the user when the backlight is turned off.

(9) In the configuration of (1), it may also be that a visible light transmittance rate of the intermediate layer is 3% or more and 30% or less. In the disclosure, “visible light” refers to electromagnetic waves in a wavelength range that is perceived as light by the human eye. The wavelength range of visible light is, for example, 360 nm or more and 830 nm or less. Also, “visible light transmittance rate” τ refers to the ratio at which visible light passes through a sample (for example, the intermediate layer). With the luminosity of incident light as I0 and the luminosity of light that has passed through the sample as I, the visible light transmittance rate is expressed as τ (%)=(I/I0)×100. According to the configuration, compared to the case where the visible light transmittance rate is less than 3%, the visibility of the opening part can be improved when the backlight is turned on. Also, compared to the case where the visible light transmittance exceeds 30%, the opening part can be suppressed from being transparently displayed on the surface of the skin layer when the backlight is turned off.

(10) In the configuration of (1), it may also be that the decorative sheet is arranged on an interior member of a vehicle. According to the configuration, by switching the backlight between turning on and turning off, the design of the interior member can be provided with duality.

With the decorative sheet of the disclosure, the opening part of the design layer can be suppressed from being visually recognized when the backlight is turned off.

Hereinafter, embodiments of a decorative sheet of the disclosure will be described.

### First Embodiment

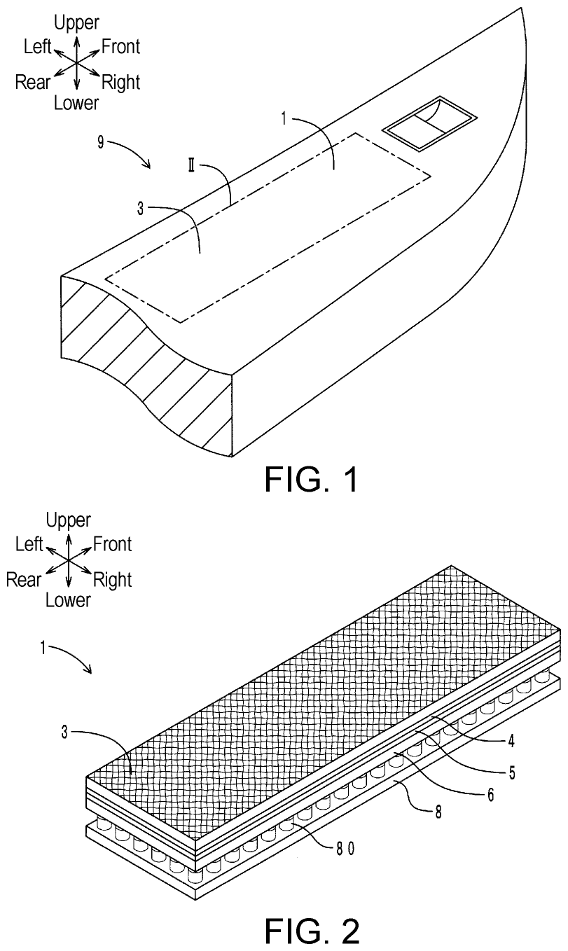

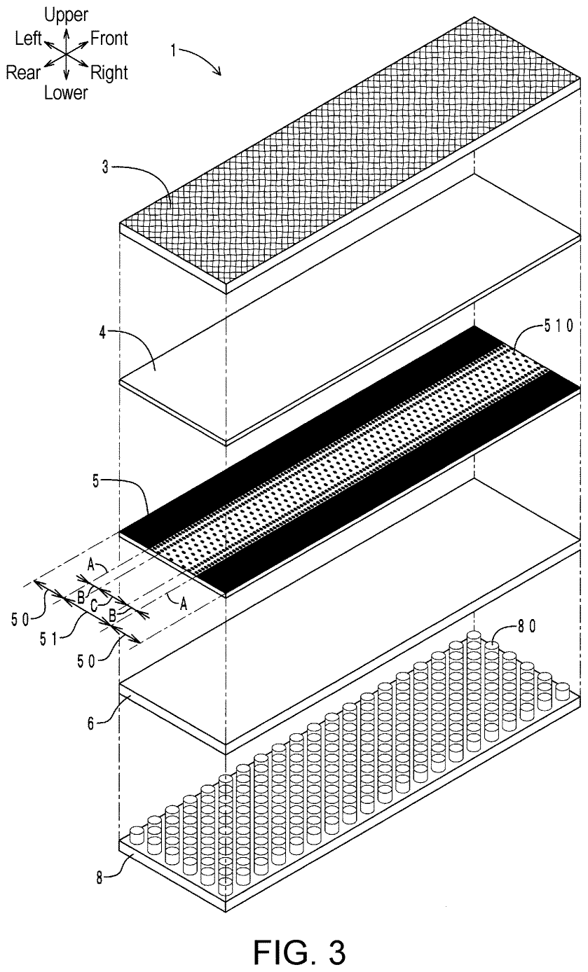

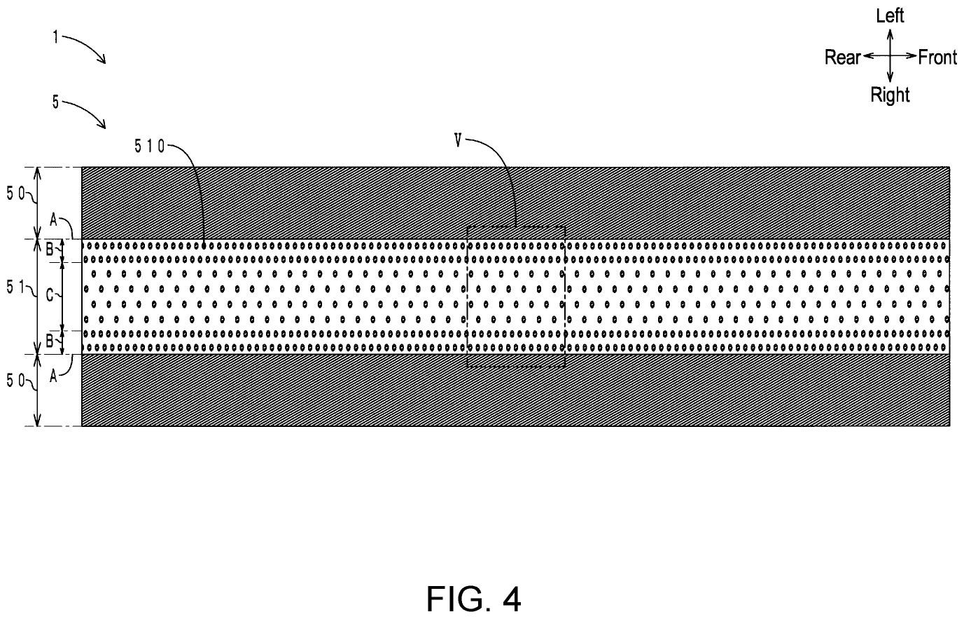

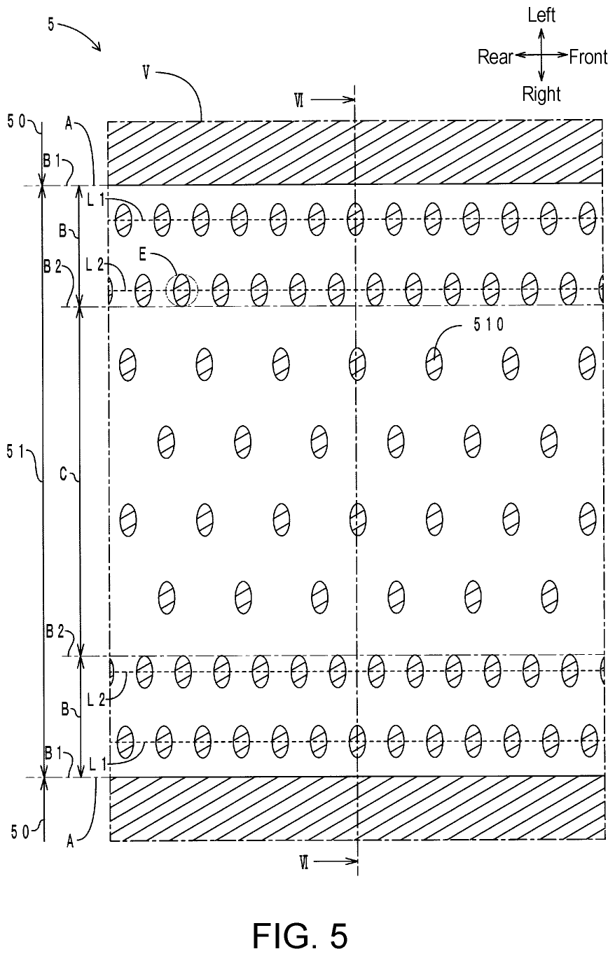

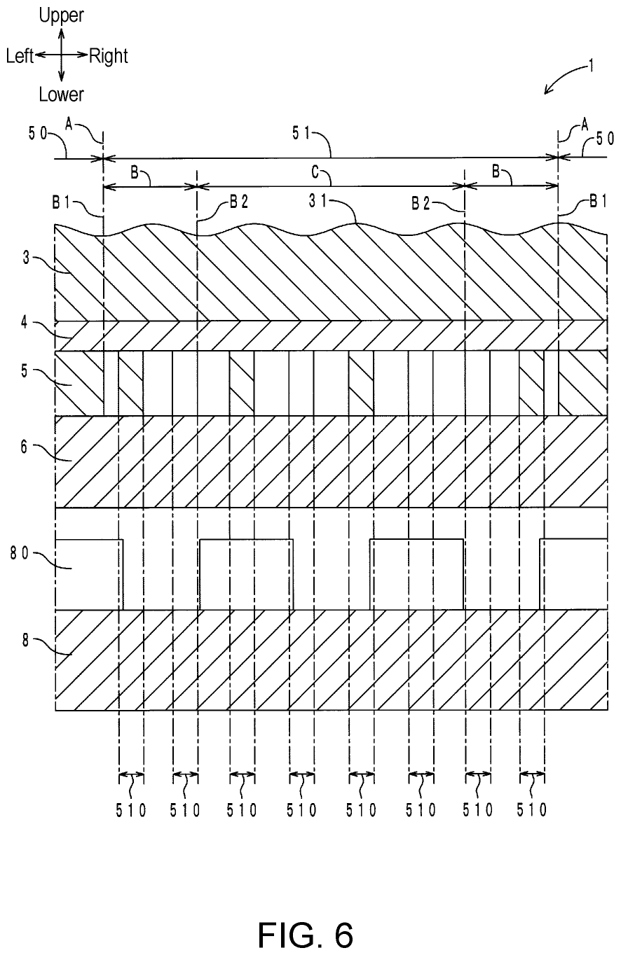

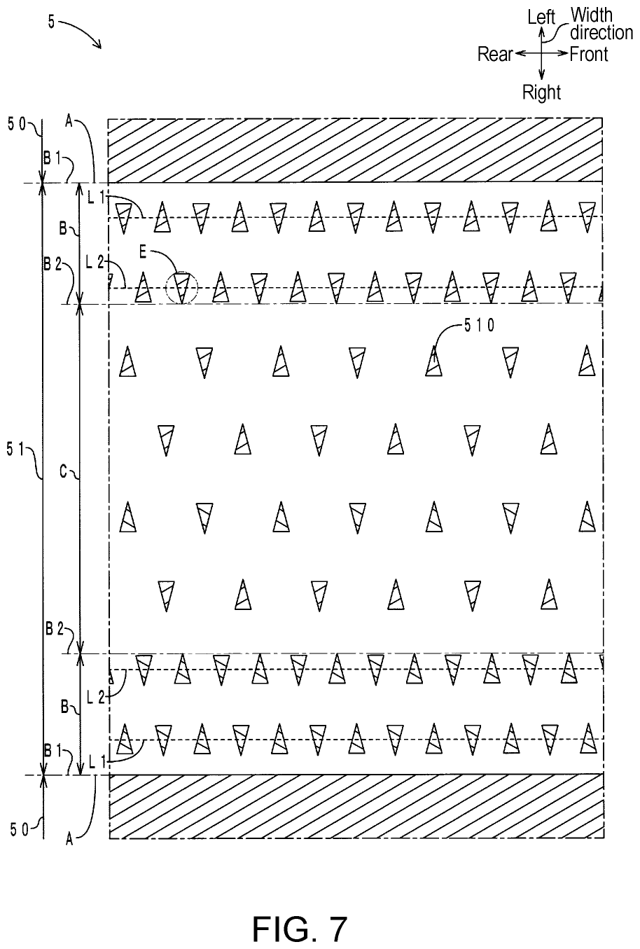

FIG. 1 shows a partial perspective view of a door trim in which a decorative sheet of the embodiment is arranged. FIG. 2 shows a perspective view inside a frame II of FIG. 1. FIG. 3 is an exploded perspective view inside the frame II of FIG. 1. FIG. 4 is a surface view of a design layer inside the frame II of FIG. 1. FIG. 5 is an enlarged view inside a frame V of FIG. 4. FIG. 6 is a cross-sectional view in a VI-VI direction of FIG. 5. In these figures, the front-rear direction corresponds to “extension direction of the boundary” of the disclosure, and the left-right direction corresponds to “width direction” and “short-side direction” of the disclosure, respectively.

### Arrangement and Configuration of Decorative Sheet

First, the arrangement and the configuration of the decorative sheet of the embodiment will be described. As shown in FIG. 1, a decorative sheet 1 is arranged on a door trim 9 of a vehicle compartment. The door trim 9 is included in the concept of “interior member” of the disclosure. As shown in FIG. 1 to FIG. 6, the door trim 9 includes the decorative sheet 1 and a light source part 8. The decorative sheet 1 and the light source part 8 are laminated in this order from the outer side (upper side, vehicle compartment interior side) toward the back side (lower side, vehicle compartment exterior side).

As shown in FIG. 3 and FIG. 6, the decorative sheet 1 includes, from the outer side toward the back side, a skin layer 3, an intermediate layer 4, a design layer 5, and a base layer 6. As shown in FIG. 1, the surface (upper surface) of the skin layer 3 is exposed to the inside of the vehicle compartment. The skin layer 3 is made of synthetic leather and exhibits a layered form. The skin layer 3 is light-transmissive and flexible. As shown in FIG. 6, the skin layer 3 includes a textured texture part 31 on the surface. The texture part 31 is arranged over the entire surface of the skin layer 3. Light is irradiated to the design layer 5 described later from the light source part 8 on the back side via the base layer 6 described later. With the light, the design of the design layer 5 (opening part 51, dot part 510, etc.,) is displayed on the surface of the skin layer 3.

As shown in FIG. 3 and FIG. 6, the intermediate layer 4 is arranged on the back side of the skin layer 3. The intermediate layer 4 is made of light-transmissive ink and exhibits a layered form. The intermediate layer 4 is light-transmissive and flexible. The intermediate layer 4 has light transmittance lower than the skin layer 3. The intermediate layer 4 is smoke-toned to be translucent. The intermediate layer 4 is colored and transparent.

As shown in FIG. 3 and FIG. 6, the design layer 5 is arranged on the back side of the intermediate layer 4. The design layer 5 exhibits a layered form. The design layer 5 is flexible. The design layer 5 has higher light transmittance than the intermediate layer 4. As shown in FIG. 3 to FIG. 5, when viewed from the outer side, the design layer 5 has two shielding parts 50, an opening part 51, and a boundary A. The two shielding parts 50 are arranged along the left and right edges of the design layer 5. The shielding part 50 exhibits a band shape extending in the front-rear direction. The shielding part 50 is made of light-shielding (light-impermeable) ink and has light-shielding properties.

As shown in FIG. 5, the opening part 51 is arranged between the two, i.e., left and right, shielding parts 50 (on the inner side in the left-right direction). The opening part 51 is a space that is light-transmissive. The opening part 51 is arranged adjacent to the shielding part 50 via the boundary A. The opening part 51 exhibits a band shape extending in the front-rear direction. When viewed from the outer side, multiple dot parts 510 are dispersedly arranged in the opening part 51. Specifically, inside the opening part 51, the dot parts 510 are arranged so as to become sparse from dense toward the inner side of the opening part 51 (the center of the opening part 51 in the left-right direction) from the boundary A. The dot part 510 exhibits an elliptical shape that is long in the left-right direction. The areas of the dot parts 510 are uniform. The dot part 510 is made of light-shielding ink and has light-shielding properties. The opening part 51 (specifically, the portion inside the opening part 51 where the dot part 510 is not arranged; dot-free portion) has higher light transmittance than the shielding part 50 and the dot part 510. The dot part 510 has light transmittance that is the same as or higher than the shielding part 50. That is, the height relationship of light transmittance is, from higher to lower, “opening part 51>dot part 510≥shielding part 50”.

In the opening part 51, left and right two outside dot areas B and an inside dot area C are defined. The outside dot area B is arranged inside the opening part 51 and adjacent to the boundary A. The inside dot area C is arranged inside the opening part 51 and on the inner side of the outside dot area B in the left-right direction, adjacent to the outside dot area B. The dot parts 510 are arranged densely in the outside dot area B and sparsely in the inside dot area C.

As shown in FIG. 6, the base layer 6 is arranged on the back side of the design layer 5. The base layer 6 is made of thermoplastic elastomer and is flexible, light-transmissive, and light-diffusive. The light from the light source 80 is diffused by the base layer 6 in the edgewise direction (layer spreading direction; a direction intersecting the lamination direction (vertical direction); surface direction). For this reason, the surface of the base layer 6 emits light over the entire surface.

As shown in FIG. 6, the light source part 8 is arranged on the back side of the base layer 6 of the decorative sheet 1. The light source part 8 includes multiple light sources (LEDs) 80. The light sources 80 are distributed throughout the light source part 8 in the edgewise direction. The light from the light source 80 reaches the surface of the door trim 9 via the base layer 6, the design layer 5, the intermediate layer 4, and the skin layer 3.

### Manufacturing Method of Decorative Sheet

Next, the manufacturing method of the decorative sheet of the embodiment will be described. The manufacturing method of the decorative sheet 1 includes an intermediate layer printing process, a design layer printing process, and a base layer arrangement process. The manufacturing method is executed in a state where the decorative sheet 1 shown in FIG. 1 to FIG. 4 is set upside down. In the intermediate layer printing process, the intermediate layer 4 is printed on the back surface (upper surface) of the skin layer 3 with the texture part 31 by a silk screen printer. In the case where the intermediate layer 4 has a multi-layer structure (for example, a structure having a surface layer (transparent layer) and a back layer (colored layer)), the respective layers are printed in order. In the design layer printing process, the design layer 5 is printed on the back surface (upper surface) of the intermediate layer 4 by a silk screen printer. Specifically, the two shielding parts 50 are printed on both sides of the opening part 51 in the left-right direction, and the dot parts 510 are printed inside the opening part 51. In the base layer arrangement process, the base layer 6 formed in advance is laminated on the back surface of the design layer 5.

### Operational Effect

Next, the operational effect of the decorative sheet of the embodiment will be described. Hypothetically, the case where the dot parts 510 are not arranged inside the opening part 51 is assumed. In this case, when the backlight is turned off (when the light source part 8 is turned off), a portion of the light incident on the decorative sheet 1 from the outer side of the skin layer 3 is reflected on the surface of the shielding part 50 (reflection of the shielding part 50) and is visually recognized by the user. Also, when the backlight is turned off, another portion of the light incident on the decorative sheet 1 from the outer side of the skin layer 3 transmits through the opening part 51, is reflected on the surface of the base layer 6 (reflection of the base layer 6), and is visually recognized by the user.

Here, a difference occurs between the reflection of the shielding part 50 and the reflection of the base layer 6 due to the difference in light reflectance between the surface of the shielding part 50 and the surface of the base layer 6. Therefore, the boundary A becomes easily visually recognized by the user.

Regarding this point, as shown in FIG. 5, according to the decorative sheet 1 of the embodiment, the dot parts 510 are arranged inside the opening part 51. The dot parts 510 are arranged so as to become sparse from dense from the boundary A between the shielding part 50 and the opening part 51 toward the inner side of the opening part 51. By densely arranging the dot parts 510 near the boundary A that is easily visually recognized when the backlight is turned off, the boundary A can be blurred. Therefore, the boundary A can be suppressed from being visually recognized by the user.

Also, as shown in FIG. 6, on the side surface of the dot part 510 (a surface extending in the lamination direction (outer-back direction, vertical direction), a surface connecting the outer surface and the back surface), at least one of absorption, attenuation, and reflection of the light reflected on the base layer 6 surface occurs. For this reason, the boundary (the outer edge of the dot part 510) between the dot part 510 and the portion inside the opening part 51 where the dot part 510 is not arranged (dot-free portion) can be blurred.

The base layer 6 made of thermoplastic elastomer has multiple pores. Macroscopically, the surface of the base layer 6 is white. For this reason, the surface of the base layer 6 easily reflects light. Therefore, when the backlight is turned off, the boundary A is easily visually recognized. The decorative sheet of the disclosure is suitable for the decorative sheet 1 having the base layer 6 with high light reflectivity.

As shown in FIG. 5, when viewed from the outer side, inside the opening part 51, the outside dot area B where the dot parts 510 are densely arranged and the inside dot area C where the dot parts 510 are sparsely arranged are defined. With the two types of dot areas, the dot parts 510 can be arranged so as to become sparse from dense from the boundary A toward the inner side of the opening part 51 (inner side in the left-right direction).

As shown in FIG. 5, among both ends of the outside dot area B in the left-right direction, the end on the side of the shielding part 50 is defined as an outside end B1 (that is, the boundary A). Also, among both ends of the outside dot area B in the width direction, the end on the side of the opening part 51 is defined as an inside end B2. With the total length of the opening part 51 in the left-right direction being set as 100%, the inside end B2 is arranged at a position at or within 33% inward from the boundary A in the left-right direction. For this reason, compared to the case where the inside end B2 is arranged at a position exceeding 33% inward from the boundary A in the left-right direction, the width of the outside dot area B (area where the dot parts 510 are densely arranged) can be set narrow, and the width of the inside dot area C (area where the dot parts 510 are sparsely arranged) can be set wide. For this reason, the boundary A can be intensively blurred. Also, an excessive decrease in the light transmittance of the opening part 51 can be suppressed.

As shown in FIG. 5, when viewed from the outer side, in the outside dot area B, two dot rows L1 to L2 are arranged from the outside end B1 (boundary A) toward the inside end B2. The two dot rows L1 to L2 are aligned in the left-right direction. Each of the dot rows L1 to L2 includes the dot parts 510 connected in a linear shape (dotted line shape). Each of the dot rows L1 to L2 extends in the front-rear direction.

In the two dot rows L1 to L2, the spacing between a pair of dot parts 510 adjacent in the front-rear direction is the same. That is, the spacing between a pair of adjacent dot parts 510 is set so that the dot row L1 is equal to the dot row L2. For this reason, the arrangement density of the dot parts 510 in the outside dot area B (the arrangement quantity of the dot parts 510 per unit area in any of the dot rows L1 to L2) is uniform from the boundary A toward the inner side of the opening part 51. Therefore, the occurrence of the boundary in the arrangement density of the dot parts 510 in the outside dot area B can be suppressed. Also, since the boundary in the arrangement density of the dot parts 510 itself is unlikely to occur, the light transmittance tends to be uniform throughout the entire outside dot area B. For this reason, when the backlight is turned on (when the light source part 8 is turned on), it is difficult for the user to visually recognize the difference in luminosity.

As shown in FIG. 5, when viewed from the outer side, with the area of the inside dot area C as 100%, the total area of the dot parts 510 in the inside dot area C is 25% or more and 50% or less. For this reason, compared to the case where the total area of the dot parts 510 is less than 25%, it is possible to suppress the opening part 51 from being visually recognized by the user when the backlight is turned off. Also, compared to the case where the total area of the dot parts 510 exceeds 50%, it is possible to suppress the decrease in the light transmittance of the opening part 51 when the backlight is turned on.

As shown in FIG. 5, when viewed from the outer side, the long axis of the elliptical dot part 510 extends in the left-right direction. Both the left and right ends of the long axis are in contact with a circumscribed circle E. The diameter of the circumscribed circle E is 1.5 mm or less. For this reason, compared to the case where the diameter of the circumscribed circle E (that is, the length of the long axis of the dot part 510) exceeds 1.5 mm, it is possible to suppress the dot part 510 itself from being visually recognized by the user when the backlight is turned off.

As shown in FIG. 4, when viewed from the front side, the opening part 51 extends in a strip shape in the front-rear direction (longitudinal direction). The length of the opening part 51 in the left-right direction is 3 mm or more. That is, the aspect ratio of the opening part 51 is (length in left-right direction:length in front-rear direction)=(1:more than 1). In the case where the left-right direction length (opening width) of the opening part 51 is 3 mm or more, the boundary A tends to be easily visually recognized by the user when the backlight is turned off.

Regarding this point, according to the decorative sheet 1 of the embodiment, the dot parts 510 are arranged in an area where the blurring effect of the boundary A can be effectively exhibited (an area where the length of the opening part 51 in the left-right direction is 3 mm or more). For this reason, it is possible to suppress the boundary A from being visually recognized by the user when the backlight is turned off.

As shown in FIG. 6, the visible light transmittance rate of the intermediate layer 4 is 3% or more and 30% or less. For this reason, compared to the case where the visible light transmittance rate of the intermediate layer 4 is less than 3%, the visibility of the opening part 51 when the backlight is turned on can be improved. Also, compared to the case where the visible light transmittance rate of the intermediate layer 4 exceeds 30%, it is possible to suppress the opening part 51 from being transparently displayed on the surface of the skin layer 3 when the backlight is turned off. Hereinafter, the method for measuring visible light transmittance rate will be described. First, in a dark room without illumination, a sample is set on an LED light source (luminance 3000 cd/m²), and the LED light source is turned on. Next, at a position 1000 mm away from the measurement location of the sample (a circular portion with a diameter of approximately 4 mm), the luminosity I0 of incident light and the luminosity I of light that has passed through the sample are measured by using a color luminance meter (manufactured by Konica Minolta, Inc., model number CS-160). Thereafter, from the measurement results, the visible light transmittance rate is calculated by using the formula: visible light transmittance rate τ (%)=(I/I0)×100.

As shown in FIG. 1, the decorative sheet 1 of the embodiment is arranged on the door trim 9, which is an interior member of a vehicle. For this reason, by switching the backlight between turning on and turning off, the design of the door trim 9 can be provided with duality.

The manufacturing method of the decorative sheet 1 includes an intermediate layer printing process and a design layer printing process. For this reason, compared to the case where the intermediate layer 4 is a coating film or the like, for example, variation in the layer thickness of the intermediate layer 4 can be suppressed. Also, the layer thickness of the intermediate layer 4 can be suppressed from becoming excessively large. The design layer 5 also has the same effect as the intermediate layer 4. Also, the positional displacement in the edgewise direction among the three layers (the skin layer 3, the intermediate layer 4, and the design layer 5) can be suppressed.

### Second Embodiment

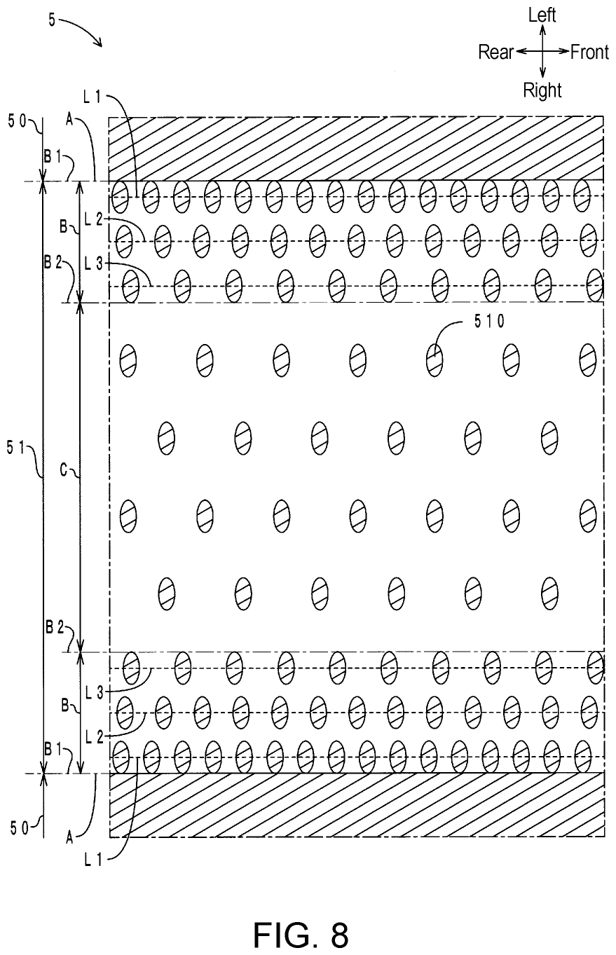

The difference between the decorative sheet of the embodiment and the decorative sheet of the first embodiment is that the dot part exhibits an isosceles triangle shape. Here, only the difference will be described. FIG. 7 shows a partial surface view of a design layer of a decorative sheet of the embodiment. Parts corresponding to those in FIG. 5 are indicated by the same reference numerals.

As shown in FIG. 7, when viewed from the outer side, the dot part 510 exhibits an isosceles triangle shape extending in the left-right direction. In any dot row L1 to L2, any pair of dot parts 510 adjacent in the front-rear direction are arranged such that the orientations of the vertices or bases are opposite to each other in the left-right direction. That is, the dot parts 510 are arranged in a staggered pattern.

The decorative sheet of the embodiment and the decorative sheet of the first embodiment have the same operational effects with respect to the portions having a common configuration. As in the decorative sheet of the embodiment, the shape of the dot part 510 may be an isosceles triangle shape. Also, the dot parts 510 may be arranged in a staggered pattern.

### Third Embodiment

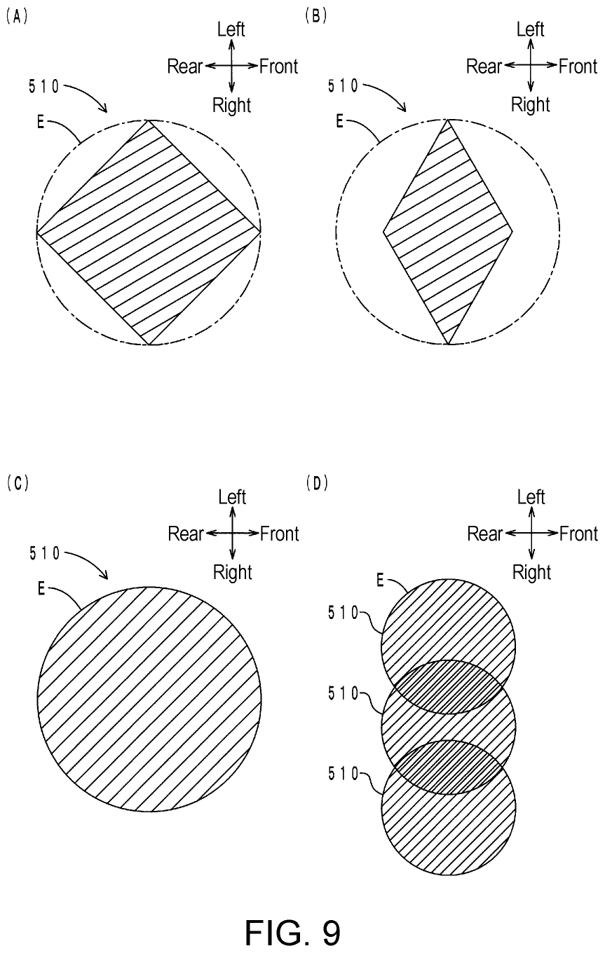

The difference between the decorative sheet of the embodiment and the decorative sheet of the first embodiment is that the arrangement density of the dot parts in the outside dot area gradually decreases from the boundary toward the inner side of the opening part. Here, only the difference will be described. FIG. 8 shows a partial surface view of a design layer of a decorative sheet of the embodiment. Parts corresponding to those in FIG. 5 are indicated by the same reference numerals.

As shown in FIG. 8, when viewed from the outer side, in the outside dot area B, three dot rows L1 to L3 are arranged from the outside end B1 (boundary A) toward the inside end B2. The three dot rows L1 to L3 are aligned in the left-right direction. The dot rows L1 to L3 include the dot parts 510 connected in a linear (dotted line) manner. The dot rows L1 to L3 extend in the front-rear direction.

In the three dot rows L1 to L3, the interval between a pair of adjacent dot parts 510 is set to gradually increase (to gradually become wider). That is, the interval between a pair of adjacent dot parts 510 is set in the order of dot row L1→dot row L2→dot row L3 from the narrowest. Therefore, the arrangement density of the dot parts 510 in the outside dot area B is gradually reduced (gradually decreases) from the boundary A toward the inner side of the opening part 51.

The decorative sheet of the embodiment and the decorative sheet of the first embodiment have the same operational effects with respect to the portions having a common configuration. Hypothetically, the case where, in the three dot rows L1 to L3, the arrangement density of the dot parts 510 changes abruptly from the boundary A toward the inner side of the opening part 51 is assumed. In this case, when the backlight is turned off, the boundaries (boundaries of the arrangement density of the dot parts 510) between adjacent dot rows (dot row L1 and dot row L2, dot row L2 and dot row L3) become easier for the user to visually recognize. Regarding this point, according to the decorative sheet of the embodiment, in the three dot rows L1 to L3, the arrangement density of the dot parts 510 gradually decreases from the boundary A toward the inner side of the opening part 51. Therefore, the boundaries between the adjacent dot rows L1 to L3 can be blurred.

Furthermore, the light transmittance differs between the portion where the arrangement density of the dot parts 510 is high and the portion where the arrangement density is low. Therefore, in the three dot rows L1 to L3, in the case where the arrangement density of the dot parts 510 changes abruptly from the boundary A toward the inner side of the opening part 51, the difference in light transmittance increases. Accordingly, when the backlight is turned on, the difference in luminosity is easy for the user to visually recognize. In this regard, according to the decorative sheet of the embodiment, in the three dot rows L1 to L3, the arrangement density of the dot parts 510 gradually decreases from the boundary A toward the inner side of the opening part 51. Therefore, the difference in light transmittance is small. Therefore, when the backlight is turned on, the difference in luminosity is difficult for the user to visually recognize.

### Others

The embodiments of the decorative sheet of the disclosure have been described above. However, the embodiments are not particularly limited to the above forms. Implementation is also possible in various modified forms and improved forms that can be made by those skilled in the art.

### Regarding Configuration

The shape of the surface of the dot part 510 is not particularly limited. (A) of FIG. 9 to (D) of FIG. 9 show surface views of the dot parts of the decorative sheets of other embodiments (first to fourth). Parts corresponding to those in FIG. 5 are indicated by the same reference numerals.

As shown in (A) of FIG. 9, the dot part 510 may be square. Of course, other regular polygons (equilateral triangle, regular pentagon, regular hexagon, etc.,) may also be used. Additionally, rectangles, parallelograms, and the like may also be used. That is, the shape of the dot part 510 may have isotropy or may have anisotropy.

As shown in (B) of FIG. 9, the dot part 510 may be rhombus-shaped. When the dot part 510 has anisotropy, such as the rhombus-shaped dot part 510, the long axis direction is not particularly limited. The long axis direction may be the left-right direction, the front-rear direction, or the diagonal direction (a direction intersecting the left-right direction and the front-rear direction). It suffices as long as the outer edge of the dot part 510 is in contact with the circumscribed circle E at least at two points.

As shown in (C) of FIG. 9, the dot part 510 may be perfectly circular. In this case, the outer edge of the dot part 510 coincides with the circumscribed circle E. As shown in (D) of FIG. 9, the dot parts 510 may be connected to each other. The dot parts 510 connected to each other may be displayed as a line. Additionally, hatching may be displayed by overlapping multiple lines. The continuous direction of the dot parts 510 is not particularly limited. It may be the left-right direction, the front-rear direction, or the diagonal direction. The areas of the dot parts 510 may be the same or different.

The arrangement of the dot parts 510 in the opening part 51 is not particularly limited. The dot parts 510 may be arranged regularly or irregularly. It suffices as long as the dot parts 510 are arranged to become sparse from dense toward the inner side of the opening part 51 from the boundary A.

The extension directions of the dot rows L1 to L3 shown in FIG. 5, FIG. 7, and FIG. 8 are not particularly limited. It may be the left-right direction, the front-rear direction, or the diagonal direction. The direction in which the dot rows L1 to L3 are juxtaposed is not particularly limited. It may be the left-right direction, the front-rear direction, or the diagonal direction. In any of the dot rows L1 to L3, the spacing between a pair of adjacent dot parts 510 is not particularly limited. The spacing may be uniform or non-uniform.

The shape of the side surface of the dot part 510 is not particularly limited. The shape may be a planar shape extending in the lamination direction, a convex shape bulging in the edgewise direction, a concave shape recessed in the edgewise direction, or a shape combining at least two of the surface shapes.

The shape, position, arrangement quantity, and the like of the opening part 51, the dot part 510, and the shielding part 50 in the design layer 5 are not particularly limited. The light transmittance properties of the opening part 51, the dot part 510, and the shielding part 50 is not particularly limited. It suffices as long as the height relationship of light transmittance is “opening part 51>dot part 510>shielding part 50” from highest to lowest. Alternatively, it suffices as long as the height relationship of light transmittance is “opening part 51>dot part 510=shielding part 50” from highest to lowest.

The layer structure of each layer (the skin layer 3, the intermediate layer 4, the design layer 5, the base layer 6) is not particularly limited. It may be a single-layer structure or a multi-layer structure. Among the respective layers, another layer may be interposed between two layers adjacent in the outer-back direction. Also, another layer may be arranged on the outer side of the skin layer 3.

The difference in area among the respective layers when viewed from the outer side is not particularly limited. For example, when viewed from the outer side, the intermediate layer 4 and the design layer 5 may be arranged on a portion of the skin layer 3. Also, when viewed from the outer side, the design layer 5 may be arranged on a portion of the intermediate layer 4. Also, when viewed from the outer side, the intermediate layer 4 may be arranged on a portion of the design layer 5.

The color of the design displayed on the skin layer 3 may be a single color or multiple colors. The color may be expressed on the surface of the skin layer 3 by one or more selected from each layer and the light source part 8. The light transmittance and transparency properties of each layer (excluding the shielding part 50 of the design layer 5) are not particularly limited. The light transmittance and transparency properties may be colorless transparent, colored transparent, translucent, or the like. The color (hue, saturation, brightness) of each layer and the light source 80 is not particularly limited. The skin layer 3 does not have to have the texture part 31. The surface of the skin layer 3 may be, for example, a smooth surface.

The position and the arrangement quantity of the light source 80 in the light source part 8 are not particularly limited. Also, a single light source 80 may include multiple LEDs. In this case, the colors of the LEDs may be different from each other. For example, in the case where one single light source 80 includes LEDs of three colors of red, green, and blue, white light can be irradiated in addition to red, green, and blue.

The brightness of the light source 80 is not particularly limited. The type, arrangement quantity, and position of the light source 80 are not particularly limited. The light source 80 may be an organic EL sheet, an inorganic EL sheet, a luminous sheet, etc. Also, the light source part 8 may include the light source 80 and a light guide plate (for example, an acrylic plate).

The type of interior member on which the decorative sheet 1 is arranged is not particularly limited. Examples may include the door trim 9, seat, armrest, floor, ceiling, instrument panel, glove box, steering wheel, center console, register, etc. The surface of the interior member (the surface of the skin layer 3) may be a flat surface or a curved surface. The orientation of the interior member (the orientation of the decorative sheet 1 in the outer-back direction) is not particularly limited. That is, the outer-back direction may be a vertical direction, a horizontal direction, or a direction intersecting the vertical direction and the horizontal direction. The decorative sheet 1 may be arranged on an interior member of a transportation machine other than vehicles (motorcycles, ships, aircraft, etc.), a building (houses, etc.), etc. Also, the decorative sheet 1 may be arranged on an exterior member (exterior walls of transportation machines, buildings, etc.)

### Regarding Materials

The material of the skin layer 3 is not particularly limited. Examples may include synthetic leather, resin, elastomer, nonwoven fabric, various fabrics (woven fabric, knitted fabric, etc.), etc. As the synthetic leather, examples may include resin, and elastomer, specifically, acrylic, polyethylene terephthalate, polycarbonate, polyvinyl chloride, silicone, epoxy, polyurethane, styrene-based thermoplastic elastomer, olefin-based thermoplastic elastomer, dynamically crosslinked thermoplastic elastomer, etc. As the nonwoven fabric and various fabrics, examples may include polyester, polypropylene, nylon, cotton, etc. The skin layer 3 may contain a colorant (colored polyethylene, etc.), a light diffusing agent (silicone, acrylic, titanium oxide, etc.), and a light absorbing agent (titanium black, carbon black, etc.)

The material of the intermediate layer 4 is not particularly limited. Examples may include resin, elastomer, etc., such as acrylic, polyethylene terephthalate, polycarbonate, polyvinyl chloride, silicone, polyester, epoxy, polyurethane, styrene-based thermoplastic elastomer, olefin-based thermoplastic elastomer, dynamically crosslinked thermoplastic elastomer, etc. The intermediate layer 4 may contain the colorant, light diffusing agent, and light absorbing agent.

The material of the design layer 5 (the shielding layer 50, the dot part 510) is not particularly limited. Examples may include resin, elastomer, etc., such as acrylic, polyethylene terephthalate, polycarbonate, polyvinyl chloride, silicone, polyester, epoxy, polyurethane, styrene-based thermoplastic elastomer, olefin-based thermoplastic elastomer, dynamically crosslinked thermoplastic elastomer, etc. The design layer 5 may contain the colorant, light diffusing agent, and light absorbing agent.

The opening part 51 may be hollow (provided with a space) or solid. Specifically, the portion (dot-free part) inside the opening part 51 where the dot part 510 is not arranged may be hollow or solid. In the case where the dot-free part is solid, the material of the dot-free portion may be the same as the material of the design layer 5 (resin, elastomer). Of course, the dot-free part may contain the colorant, light diffusing agent, and light absorbing agent. In the case where the dot-free portion is solid, the height relationship of light transmittance may be “dot-free part>dot part 510>shielding part 50” from highest to lowest. Alternatively, the height relationship of light transmittance may be “dot-free part>dot part 510=shielding part 50” from highest to lowest.

The material of the base layer 6 is not particularly limited. Examples may include elastomers and resins. Specifically, examples may include elastomers such as styrene-based thermoplastic elastomer, olefin-based thermoplastic elastomer, dynamically crosslinked thermoplastic elastomer, styrene-based thermoplastic elastomer, and olefin-based thermoplastic elastomer. In addition, examples may include foams such as polyurethane foam and the like. In addition, examples may include resins such as acrylic, polyethylene terephthalate, polycarbonate, polyvinyl chloride, silicone, polyester, and epoxy.

In the case where the intermediate layer 4 and the base layer are light-diffusive, the method for imparting the light diffusivity is not particularly limited. For example, a light diffusing agent (silicone, acrylic, titanium oxide, etc. ,) having a refractive index different from that of the base material may be dispersed in a transparent base material.

The lamination method of each layer is not particularly limited. Screen printing (silk screen printing, etc.), gravure printing, inkjet printing, flexographic printing, etc., may be used. Also, each layer may be laminated by adhesion, pressure bonding, sticking, vapor deposition, welding, coating, etc. A film-shaped layer (for example, design layer 5) may be adhered to the back surface of an arbitrary layer (for example, intermediate layer 4). Also, a layer (for example, intermediate layer 4) may be coated on the back surface of an arbitrary layer (for example, skin layer 3).

What is claimed is:

1. A decorative sheet, comprising:
a skin layer, being light-transmissive;
an intermediate layer, arranged on a back side of the skin layer and being light-transmissive;
a design layer, arranged on a back side of the intermediate layer; and
a base layer, arranged on a back side of the design layer and being light-transmissive,
wherein:
when viewed from an outer side, the design layer has a shielding part and an opening part arranged adjacent to the shielding part via a boundary,
when viewed from the outer side, a plurality of dot parts are arranged inside the opening part,
the dot parts are arranged so as to become sparse from dense toward an inner side of the opening part from the boundary,
the opening part has higher light transmittance than the shielding part and the dot parts, and
the dot part has light transmittance equal to or higher than the shielding part.

2. The decorative sheet as claimed in claim 1, wherein:
when viewed from the outer side, inside the opening part,
an outside dot area arranged adjacent to the boundary, and an inside dot area arranged adjacent to the outside dot area are defined, and
in the outside dot area, the dot parts are densely arranged relative to the inside dot area.

3. The decorative sheet as claimed in claim 1, wherein:
a direction orthogonal to an extension direction of the boundary is defined as a width direction,
among both ends of the outside dot area in the width direction, an end on a side of the shielding part is defined as an outside end, and an end on a side of the opening part is defined as an inside end,
wherein:
the outside end is the boundary, and
when a total length of the opening part in the width direction is defined as 100%, the inside end is arranged at a position at or within 33% inward from the boundary in the width direction.

4. The decorative sheet as claimed in claim 2, wherein, when viewed from the outer side, an arrangement density of the dot parts in the outside dot area gradually decreases from the boundary toward an inner side of the opening part.

5. The decorative sheet as claimed in claim 2, wherein when viewed from the outer side, an arrangement density of the dot parts in the outside dot area is uniform.

6. The decorative sheet as claimed in claim 2, wherein when viewed from the outer side, when an area of the inside dot area is defined as 100%, a total area of the dot parts in the inside dot area is 25% or more and 50% or less.

7. The decorative sheet as claimed in claim 1, wherein when viewed from the outer side, a diameter of a circumscribed circle of the dot part is 1.5 mm or less.

8. The decorative sheet as claimed in claim 1, wherein when viewed from the outer side, the opening part exhibits a band shape, and
a length of the opening part in a short-side direction is 3 mm or more.

9. The decorative sheet as claimed in claim 1, wherein a visible light transmittance rate of the intermediate layer is 3% or more and 30% or less.

10. The decorative sheet as claimed in claim 1, wherein the decorative sheet is arranged on an interior member of a vehicle.
